(19) United States
(12) Patent Application Publication
(10) Pub. No.: US 2019/0378073 A1
(43) Pub. Date: Dec. 12, 2019

(54) Business-Aware Intelligent Incident and Change Management

(71) Applicant: JPMorgan Chase Bank, N.A., New York, NY (US)

(72) Inventors: Melvin LOPEZ, Brooklyn, NY (US); Jessie Rincon-Paz, Wallis, TX (US)

(21) Appl. No.: 16/436,524

(22) Filed: Jun. 10, 2019

Related U.S. Application Data
(60) Provisional application No. 62/682,432, filed on Jun. 8, 2018.

(51) Int. Cl. G06Q 10/06; G06N 20/00

(52) U.S. Cl. CPC G06Q 10/06375; G06N 20/00; G06Q 10/0635

(57) ABSTRACT

Systems and methods for prioritizing and tracking incidents and changes that occur in an information technology infrastructure are provided. The systems and methods may automatically detect incidents and changes and determine associated risk and impact of the incident or change using machine learning to enhance the determination of severity of an incident or change based on a prior history of incidents and changes.

### TECHNICAL FIELD

The present disclosure generally relates to systems and methods for business-aware intelligent incident and change management. More particularly, the disclosure relates to improved systems and methods for tracking and management of changes in an business information technology environment.

### BACKGROUND

Modern information technology (IT) environments have grown exponentially as the threat and regulatory landscape has expanded. To assist in the management of the increasingly complex IT infrastructure needed to support these environments, it is common for system administrators to utilize an automated ticketing or logging system to verify and track incidents, errors, or changes needing attention. Traditional automated ticketing systems track incidents as they occur, and human support resources are left to sort through the incidents manually in order to assign priority and eventually resolve the incidents. Changes initiated by system administrators and technical personnel must ascertain the impact and risk of changes with knowledge through organizational experience in lieu of data-driven business awareness on risk and impact of change.

While automated ticketing and logging systems may accurately account for IT incidents and changes, each incident or change is treated the same, regardless of the particular relevancy or criticality to business operations. As a consequence, resources must be first directed to assess which incidents require priority. Large organizations have a limited pool of human resources qualified to support IT systems, and time directed away from resolving incidents or determining the impact of change can contribute to increased downtime and business inefficiencies.

It is therefore appreciated that a need exists for systems and methods for intelligent incident and change tracking and management capable of automatically initiating prioritization and optimized scheduling and/or repair of incidents based on business value to the organization and availability of human support resources when an automated repair is not possible.

### SUMMARY

In certain exemplary embodiments, a system for intelligent incident and change management is provided. The system comprises an active machine learning module configured to: receive application data; receive information asset data; monitor information assets to detect incidents, wherein when an incident is detected, the active machine learning module is further configured to determine and assign priority to the incident based on the application data and information asset data, legal and compliance data, business operations data; and, generate an incident report based on the detected incident and the assigned priority or determine the impact of a change to determine the time and date of implementation that poses minimal risk and impact to the firm.

In another exemplary embodiment, a system for intelligent incident and change management is provided. The system comprising an active machine learning module configured to: receive application data; receive information asset data; monitor information assets to detect incidents, wherein when an incident is detected, the active machine learning module is further configured to determine and assign priority to the incident based on the application data and information asset data; and, generate an incident report based on the detected incident and the assigned priority.

In yet another exemplary embodiment, a method for intelligent incident and change management is provided. The method comprising receiving application data; receiving information asset data; monitoring information assets to detect incidents; detecting and incident and determining and assigning a priority to the incident based at least on the application data and the information asset data; and generating an incident report based on the detected incident and assigned priority.

In yet another exemplary embodiment, a system for intelligent incident management is provided. The system comprising an active machine learning module configured to: receive application data from an application metadata module; receive information asset data form an asset inventory module; receive legal and compliance data from a legal and compliance module; receive business and operations data from a business and operations module; monitor information assets to detect incidents, wherein when an incident is detected, the active machine learning module is further configured to determine and assign priority to the incident based on one of the application data, the information asset data, the legal and compliance data, or the business and operations data; and generate an incident report based on the detected incident and the assigned priority.

Numerous other objects, features, and advantages of the present disclosure will become apparent from the following detailed description of illustrative embodiments thereof, which is to be read in connection with the accompanying drawings.

### BRIEF DESCRIPTION OF THE DRAWINGS

Numerous other features of the present disclosure will become better understood with regard to the following description and accompanying drawings in which:

FIG. 1 illustrates an exemplary intelligent incident management and tracking system;

FIG. 2 illustrates an exemplary method for intelligent incident management and tracking; and,

FIG. 3 illustrates an exemplary method for intelligent change management and tracking.

### DETAILED DESCRIPTION

Aspects and implementations of the present disclosure will be understood more fully from the detailed description given below and from the accompanying drawings of the various aspects and implementations of the disclosure. This should not be taken to limit the disclosure to the specific aspects or implementations, but is provided for explanation and understanding only.

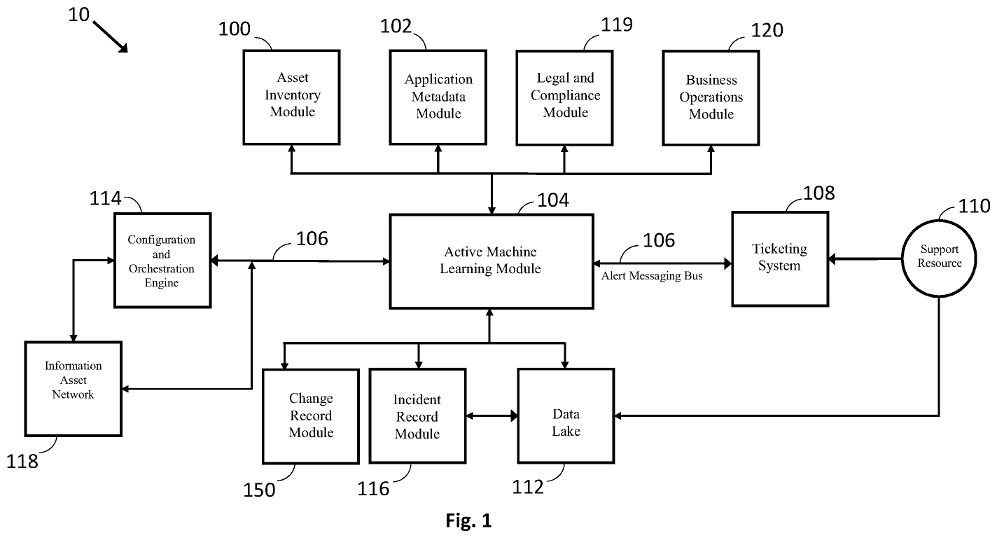

FIG. 1 shows an exemplary System 10 for intelligent incident and change management with various tracking and management features. It will be appreciated that, in certain embodiments, System 10 may be associated with the tracking, management, and/or repair of incidents and/or changes within an information technology (IT) environment. It will be further appreciated that System 10 may be readily adapted for similar use in alternative environments. System 10 comprises at least an Active Machine Learning Module 104 configured to communicate with an Application Metadata Module 102 configured to create and/or store application data and an Asset Inventory Module 100 configured to dynamically track information assets within an organization. System 10 may further comprise a Legal and Compliance Module 119 configured to identity regulatory bodies and regulations for business and/or application data, a Configuration and Orchestration Engine 114 configured to perform automated repair and/or change functions initiated by the Active Machine Learning Module 104, a Change Record Module 150 configured to record pending IT-related changes and impacted assets and timeframes for implementation and human-generated risk and impact assessments, and a Business Operations Module 120 configured to identify business processes and their criticality to an organization's business operations. It will be appreciated that the various modules and engines associated with System 10 may be used in connection with Active Machine Learning Module 104 to track and manage incidents and changes associated with an organization's IT environment.

The Active Machine Learning Module 104 is configured to communicate with the Asset Inventory Module 100, Application Metadata Module 102, Legal and Compliance Module 119, Configuration and Orchestration Engine 114, Change Record Module 150 and/or the Business Operations Module 120 over a network, for example, the Internet, intranet, etc. It is appreciated that, in some embodiments, Asset Inventory Module 100, Application Metadata Module 102, Legal and Compliance Module 119, Configuration and Orchestration Engine 114, the Business Operations Module 120 and/o Change Record Module 150 may be embodied in the same computer system or server as the Active Machine Learning Module 104. In some embodiments, Active Machine Learning Module 104, Asset Inventory Module 100, Application Metadata Module 102, Legal and Compliance Module 119, Configuration and Orchestration Engine 114 and/or the Business Operations Module 120, Change Record Module 150 may comprise one or more computers in a distributed computing environment. It will be appreciated that System 10 and its associated modules may comprise one or more computers having at least a processor in communication with a memory. In certain embodiments, System 10 may be embodied as a series of computer readable instructions stored in a computer memory, such that, when the instructions are executed by a processor, execute the various functions of System 10.

Active Machine Learning Module 104 may be configured to monitor, detect, identify, assess and/or diagnose incidents, errors and changes as they occur in a technology environment. For example, the Active Machine Learning Module 104 may be configured to monitor a payment processing system. When one or more payments fail, the Active Machine Learning Module 104 may recognize and determine the cause of the failed payment(s). In certain embodiments, Active Machine Learning Module 104 may access error information generated at a point of failure (e.g. a network or server outage) or may generate error information based on observed failure characteristics (e.g. multiple failed payments in a particular region may indicate that there is a service outage in that region). In certain embodiments, error information or alerts may be transmitted to Active Machine Learning Module 104 via Alert Messaging Bus 106.

In certain embodiments, Active Machine Learning Module 104 may be configured to analyze a change to one or more assets to assess the impact to the overall IT infrastructure or related assets. Certain changes, for example, those associated with repairing an incident, require analysis and approval from various organizational resources before they can be implemented. In order to analyze potential or pending changes, Active Machine Learning Module 104 may access change record information to assess the risk and impact of a change via defined asset, application and implementation metadata (e.g. time and date of change implementation) to determine if a change should be implemented. In some embodiments, a change will be automatically approved. In other embodiments, Active Machine Learning Module 104 may suggest a less impactful timeframe to implement the change. Current network or error information can serve to inform or withhold a change based on observed failure characteristics of upstream and downstream systems based upon business impact to the to Active Machine Learning Module 104 via Alert Messaging Bus 106.

In certain embodiments, Active Machine Learning Module 104 may comprise one or more databases storing detailed information regarding previous errors and a corresponding solution. For example, an error diagnosed as a network outage may be associated with a solution such as resetting one or more servers associated with the failures, network load balancing away from the affected servers, etc. It will be appreciated that an error may have a plurality of solutions. Data Lake 112 is a mass storage configured to communicate with the Active Machine Learning Module 104. Data Lake 112 may be configured to store enriched error data that has been processed by the Active Machine Learning Module 104. Data Lake 112 may be comprised of many local storage nodes or similarly configured as a collection of networked storage devices.

In certain embodiments, Active Machine Learning Module 104 be configured to determine if a solution may be performed automatically (e.g. by Active Machine Learning Module 104 via an associated Configuration and Orchestration Engine 114) or if the solution requires human intervention (e.g. from support resource 110). In certain embodiments, Active Machine Learning Module 104 may prioritize human resources based on availability of those resources or business or legal operational rules. Once an incident is detected, if the Active Machine Learning Module 104 determines that an automated repair is possible, the Active Machine Learning Module 104 may implement a solution and automatically repair the detected error.

Active Machine Learning Module 104 may be further configured to generate an incident report relating to a detected incident. An incident report may contain information relating to the incident, such as, for example, the type of error, type of risk, magnitude of risk, affected area, business unit, etc. Active Machine Learning Module 104 may generate an incident report using information accessed from Asset Inventory Module 100, Application Metadata Module 102, Legal and Compliance Module 119, and/or the Business Operations Module 120. If Active Machine Learning Module 104 is able to automatically diagnose and repair the detected incident, an incident report may be generated to detail what error was detected and the solution employed to resolve the error. In some embodiments, incident reports may be generated at Active Machine Learning Module 104 and transmitted to Ticketing System 108.

Incident reports may be generated by association of application metadata received from the Application Metadata Module 102 and asset attributes received from the Asset Inventory Module 100. Incident reports may additionally comprise information received from the Legal and Compliance Module 119 and/or the Business Operations Module 120. The Application Metadata Module 102 is configured to define application parameters which may be utilized by the Active Machine Learning Module 104 to determine priority of an incident. Application parameters relevant to the determination of priority may be static or dynamic. Static application parameters can relate to an application in whole or in part. For example, there may be one or more static application parameters associated with a payment application (e.g. peer-to-peer payment) as well as additional static application parameters that are related to support of that application, for example, parameters related to the processing of a payment, user authentication, user interface, etc. Static application parameters may be assigned manually or automatically recognized based on application characteristics such as operating environment or system requirements. Dynamic application parameters are not inherent in the application and may be determined based on factors such as, but not limited to, the number of active users of the application, the current network load, available processing resources, etc. Data associated with various application parameters may be received from applications in various formats. In certain embodiments, Application Metadata Module 102, Legal and Compliance Module 119 and Business Operations Module 120 is configured to enrich (e.g. enhance, refine, or otherwise improve) raw data associated with applications, assets and their associated application parameters and metadata. It will be appreciated that, in certain embodiments, Application Metadata Module 102 may be utilized by the Active Machine Learning Module 104 to determine priority of a proposed or pending change.

Application Metadata Module 102 may comprise an inventory of applications. Applications may comprise logical groupings of information assets of which one or more can exhibit errors impacting business operations. System 10 (via Application Metadata Module 102, Legal and Compliance Module 119, Business Operations Module 120 and Active Machine Learning Module 104) can provide an organization the capability to optimize incident response according to organizational priorities and/or business value. Each application may be associated with application data pertaining to business processes and services. In certain embodiments, Application Metadata Module 102, Legal and Compliance Module 119, Business Operations Module 120 may receive and store application data locally (e.g. on a computer storage) and/or access application data stored remotely (e.g. application data stored on an external server). Organizations may apply metadata “rules” to applications to denote the relative risk the organization may be exposed to in the event of an outage due to critical applications supporting the organization. For example, business rules may describe risk data related to IT Service and Operations through missed Service Level Agreements, Regulatory Risk, Market Risk; Operational Risk, Cybersecurity Risk, Threat Intelligence, etc. Other attributes within the Application Metadata Module 102 provide specific time-based attributes to assist in prioritization as well as specific prioritization and severity attributes such as, but not limited to: Recover Point Objective (RPO), Return to Operations (RTO), Ticketing Queues, Management E-Mail Distribution Lists, Manual workarounds if an outage is unavoidable (Playbook), and Recovery Documentation. Business Operations Module 120 provide an enterprise-wide data model with specific time-based attributes to assist in prioritization as well as specific prioritization and severity attributes such as, but not limited to: business service or process systemic impact in time, business service or process magnitude of impact, business process/service throughput requirements, etc. Legal and Compliance Module 119, provides an inventory of regulations and regulatory bodies one or more business processes or services are subject to by jurisdiction, geo-political location or data handling requirements.

Application Metadata Module 102 may further comprise information regarding application support and business continuity along with associated communication and alerting methods for application support to be utilized by Active Machine Learning Module 104 and/or Support Resource 110. In some embodiments, Application Metadata Module 102 may be configured to develop associations between applications to establish dependencies between applications. In certain embodiments, Active Machine Learning Module 104 may use application dependencies to create one or more subsets of tasks related to resolving an incident. For example, in a payment processing failure related incident, Active Machine Learning Module 104 may prioritize the most critical aspect of the failed system, (e.g. moving funds from one party to another) over less critical aspects (e.g. advertising). It will be appreciated that, in certain embodiments, Active Machine Learning Module 104 may assign priority to subsets of multiple incidents.

Business Operations Module 120 Business Operations Module 120 may be configured to develop associations between applications to establish dependencies between business processes and services. For example, financial services organizations have critical processes such as those associated with processing payments. These processes may be associated with metadata which can be used by the Active Machine Learning Module 104 to identify and quantify which business process that, when not functional, may damage a company's reputation or expose the firm to unacceptable risk. In some embodiments, Business Operations Module 120 may be configured to identify attributes related to various business processes that are based on timing and duration of an incident (e.g. Systemic Impact in Time, Magnitude of Impact in Dollars, Regulatory Impact in Time). By identifying these timing and duration attributes Business Operations Module 120 may be used by Active Machine Learning Module 104 to identify a point in time that an incident, such as a service outage, will have a certain financial, regulatory, and/or operational impact to the organization. Such impacts can be represented using financial metrics based on regulatory risk (e.g. potential fines against the organization), operational risk (e.g. systemic loss), financial risk (e.g. opportunity loss, dollar cost per min, day, month, etc.), and/or qualities risk (e.g. reputational damage to the organization). Business Operations Module 120 may also comprise business value information for applications which support various business operations. These factors may be considered by considered by Active Machine Learning Module 104 in accordance with organizational priorities when making a decision regarding priority. In certain embodiments Active Machine Learning Module 104 may use business dependencies to create one or more subsets of tasks related to resolving an incident impacting a business process or service. For example, in a payment processing failure related incident, Active Machine Learning Module 104 may prioritize the most critical aspect of the failed system supporting payment execution in lieu of the payment originating aspect of the failed system, (e.g. repairing execution application or infrastructure) over less critical aspects (e.g. payment origination). It will be appreciated that, in certain embodiments, Active Machine Learning Module 104 may assign priority to subsets of multiple incidents.

The Asset Inventory Module 100 is configured to quantify organizational IT assets. In some embodiments, the Asset Inventory Module 100 is in communication with networked assets and operable to determine an asset status in real-time or near real-time. The Asset Inventory Module 100 may be configured to track and maintain asset attributes such as location, operating system, system configuration, user profiles, and other technological attributes. One or more of these attributes are used to qualify the IT assets. In addition to information and data received via Asset Inventory Module 100 and Application Metadata Module 102, Active Machine Learning Module 104 may access business operations data from Legal and Compliance Module 119 and Business Operations Module 120.

Legal and Compliance Module 119 may further comprise information regarding regulatory bodies and regulations to be utilized by Active Machine Learning Module 104. Various applications may be associated with various legal and compliance regulations concerning how data is handled, for example, documentation requirements for responding to a data breach or security requirements for confidential vs. non-confidential data. Applications which retain sensitive data (e.g. credit card information) may be required to adhere to local or geo-political regulations on data retention, confidentiality and integrity. Because of the nature of some applications, application data obtained and/or stored in one jurisdiction may be subject to different regulations than similar application data store in a different jurisdiction. Active Machine Learning Module 104 may access data at Legal and Compliance Module 119 to determine incident priority in view of various regulatory and compliance impacts associated with the incident.

In some embodiments, Active Machine Learning Module 104 may be configured to determine a weighting factor weighting financial, regulatory, threat or operational needs and the technology assets used and associated application parameters. The weighting factor may be determined using application, business process, and/or business process parameters. In some embodiments, the weighting factor may be set manually. The weighting factor may then be used by the Active Machine Learning Module 104 to determine incident priority.

Not all information assets are valued the same within an organization. Technological and human resources should be maximized to support those applications which have the greatest impact to the organization's critical operations and processes. Information asset valuation is performed through governance processes at the process level in the organization expressed as business rules within the Active Machine Learning Module 104. Active Machine Learning Module 104 may be configured to use a formalized governance model, for example Control Objectives for Information and Related Technologies (COBIT), an IT management framework to govern information management and a automation protocol such as the Security Content Automation Protocol (SCAP). Legal and Compliance Module 119 may utilize a formalized governance model to rationalize legal, technical, and operational requirements to create or modify business rules the Active Machine Learning Module 104 uses for intelligent incident management and to prioritize incidents and changes and resources used to resolve those incidents or implement changes.

It is appreciated that the data stored or accessed at Asset Inventory Module 100, Application Metadata Module 102, Legal and Compliance Module 119, and Business Operations Module 120 may be stored or accessed from one or more modules. For example, some business data may be stored at Application Metadata Module 102 and Business Operations Module 120. In certain embodiments, Active Machine Learning Module 104 may perform a data audit of one or more modules in order to validate that data used to determine incident priority is up to date.

As discussed above, the Active Machine Learning Module 104 is configured to detect and identify incidents or errors as they occur in the network or assess potential changes to minimize risk. The Active Machine Learning Module 104 may be configured to analyze and determine if an automated repair is possible, and implement or generate an incident report relating to the detected incident. Incident reports are generated by association of application metadata received from the Application Metadata Module 102 and asset attributes received from the Asset Inventory Module 100. Incident reports may further comprise information/data received from the Legal and Compliance Module 119 and/or Business Operations Module 120. Severity and priority of the incident may be determined by Active Machine Learning Module 104 using data received from the aforementioned modules. Once a change has been implemented, for example, repair or an incident, Active Machine Learning Module 104 may generate a change report. Once generated, change reports may be transmitted to Change Record Module 150 by the Active Machine Learning Module 104. Change Record Module 150 may visualize change records, which can be displayed at an optional user interface for Support Resource(s) 110.

Once an incident has been detected and analyzed by Active Machine Learning Module 104, an incident report may be generated. Incident or change reports may have a status such as “open”, “acknowledged”, “resolved”, etc., that describe the status of the incident. In some embodiments, a timestamp may be associated with the status to quickly indicate how long an incident has been at a certain status. Once generated, incident reports may be transmitted to Ticketing System 108 by the Active Machine Learning Module 104. Ticketing System 108 may organize incident reports as tickets which can be displayed at an optional user interface for Support Resource(s) 110.

In some embodiments, after an “open” incident report has been transmitted to Ticketing System 108, the Active Machine Learning Module 104 may be configured to determine if it can resolve the incident automatically. In some embodiments, if Active Machine Learning Module 104 determines that automated repair is possible, Active Machine Learning Module 104 may generate and transmit a request to repair to a Configuration and Orchestration Engine 114. The Configuration and Orchestration Engine 114 is configured to communicate with Ticketing System 108 to modify the incident report status (e.g. from “open” to “acknowledged”) and initiate repairs. In some embodiments, Configuration and Orchestration Engine 114 may perform a verification step to verify that the affected asset has been repaired and normal operation restored. If the repair is successful, the incident report status is changed to resolved, and returned to Active Machine Learning Module 104. If the status is not resolved, the Active Machine Learning Module 104 will reassign the incident report, including any automated attempt failure data, for investigation, for example, by Support Resource 110. It will be appreciated that, in certain embodiments, Configuration and Orchestration Engine 114 may be embodied in Active Machine Learning Module 104.

Incident reports that have been resolved may be archived at Incident Record Module 116 and retrieved by Active Machine Learning Module 104 to assist in diagnosis of future incidents and/or automatic resolution of those incidents. Incident reports may be organized at the Incident Record Module 116 by application and/or asset unique identifiers and categorized by error type. In some embodiments, Incident Record Module 116 may store incident reports on a blockchain ledger. Review of the Incident Record Module 116 provides analysis of errors across an organization by providing a catalog of errors. In certain embodiments, Incident Record Module 116 may be in communication with Data Lake 112 in order to store data related to resolved incidents.

It is further contemplated that the Active Machine Learning Module 104 may be configured to receive business data from a Support Resource 110 (e.g. via Ticketing System 108) in order to supplement the incident reports and assist in the determination of business value. The Support Resource 110 may adjust parameters and add additional business data to be considered by the Active Machine Learning Module 104 in the determination of incident priority. The Support Resource 110 may comprise many support resources designated by the organization. Support resources may include skilled technicians, critical infrastructure support engineers, customer service resources, non-critical infrastructure support engineers, non-critical customer service resources, and business support resources, etc. In certain embodiments, a plurality of Support Resources 110 may be deployed to solve incidents simultaneously. It will be appreciated that certain Support Resources 110 may have different skill sets and abilities to resolve certain incidents. In certain embodiments, Active Machine Learning Module 104 may prioritize incident reports based on the availability of certain types of Support Resources 110. In some embodiments, Ticketing System 108 is configured to receive incident reports generated by the Active Machine Learning Module 104 from errors received via the Alert Messaging Bus 106. The Ticketing System 108 may be accessed by the Support Resource 110.

In some embodiments, Active Machine Learning Module 104 may be configured to resolve incidents directly via the Alert Messaging Bus 106 that do not require intervention by a Support Resource 110 or Ticketing System 108. Incidents may be reported as resolved by an automated repair or change performed by the Active Machine Learning Module 104 and/or Configuration and Orchestration Engine 114. In some embodiments, Configuration and Orchestration Engine 114 may organize several changes required for a repair and implement the changes in an order sufficient to minimize the risk or impact associated with the repair. Information regarding the resolution of the incident is cleared in the Alert Messaging Bus 106 by the Active Machine Learning Module 104. The Active Machine Learning Module 104 may then use this information to associate incidents with verified solutions. The Active Machine Learning Module 104 may then attempt to resolve similar subsequent incidents following a known solution, or the Active Machine Learning Module 104 may use the verified solution to more adequately assign a Support Resource 110.

The Active Machine Learning Module 104 may be further configured to make decisions regarding an incident using a decision tree or pattern recognition. Active Machine Learning Module 104 may be configured to first determine if the incident is able to be resolved without a Support Resource 110. If not, then the Active Machine Learning Module 104 will determine which type of support is required to resolve the incident, either hardware, software or administrative support, and route the ticket to the appropriate Support Resource 110. Lastly, the Active Machine Learning Module 104 determines if the host asset supports a critical application or business function, thereby requiring a higher prioritization.

In certain embodiments, it is further contemplated that the Active Machine Learning Module 104 may be configured to create incident reports before an incident has been detected. The Active Machine Learning Module 104 may determine that an asset has experienced an incident based on the observed behavior of dependent or connected assets. If such a determination is made, the Active Machine Learning Module 104 may generate and transmit an incident report to the Ticketing System 108. Such predictive incident reporting is improved over time as the Active Machine Learning Module 104 is exposed to more incidents and verified solutions over time. In some embodiments, Active Machine Learning Module 104 may determine that an incident is imminent based on observed factors of connected information assets. In such an embodiment, Active Machine Learning Module 104 may resolve an underlying issue that has not yet resulted in an error or incident (e.g. a stale data backup).

In certain embodiments, The Active Machine Learning Module 104 may be configured to analyze and determine the risk or impact of a potential change, specifically, if the change is requested at a future point-in-time. In certain embodiments, the Active Machine Learning Module 104 can assess the optimal time for implementation and prevent the change from execution at the time of implementation in response to a real-time incidents cross-impacting the change. Changes are analyzed by association of application metadata received from the Application Metadata Module 102, Incident Record Module 116 and asset attributes received from the Asset Inventory Module 100, impacted assets from the Change Record Module 150. Incident reports may further comprise information/data received from the Legal and Compliance Module 119 and/or Business Operations Module 120.

In some embodiments, after an “open” change record has been transmitted to Change Record Module 150, the Active Machine Learning Module 104 may be configured to determine if any other scheduled changes are impacted or may impact the probability of success of the open change record. In some embodiments, if Active Machine Learning Module 104 determines the risk and impact of change is minimal, Active Machine Learning Module 104 will transmit approval of the change to the Change Record Module 150 and modify the change record status (e.g. from “open” to “approved”). In some embodiments, the Active Machine Learning Module 104 will initiate via the Configuration and Orchestration Engine 114 a verification step to verify that the affected change has been implemented properly and normal operation restored. If the repair is successful, the change record status is changed to successful, and returned to Active Machine Learning Module 104. If the status is not successful, the Active Machine Learning Module 104 will generate an incident report to the Incident Record Module 116, denoting an incident due to failed change, including any automated attempt failure data, for investigation, for example, by Support Resource 110. It will be appreciated that, in certain embodiments, Configuration and Orchestration Engine 114 may be embodied in Active Machine Learning Module 104.

Change records may be archived at Change Record Module 150 and retrieved by Active Machine Learning Module 104 to assist in diagnosis of future changes or development of automated implementation of changes. Change reports may be organized at the Change Record Module 150 by application and/or asset unique identifiers and categorized by error type. In some embodiments, Change Record Module 150 may store incident reports on a blockchain ledger. Review of the Change Record Module 150 provides analysis of errors across an organization by providing a catalog of changes. In certain embodiments, Change Record Module 150 may be in communication with Data Lake 112 in order to store data related to successful changes.

It is further contemplated that the Active Machine Learning Module 104 may be configured to receive business data from a Support Resource 110 (e.g. via Ticketing System 108) in order to supplement the change record and assist in the determination of risk or impact of the change. The Support Resource 110 may adjust parameters and add additional business data to be considered by the Active Machine Learning Module 104 in the determination of change approval and scheduling. The Support Resource 110 may comprise many support resources designated by the organization. Support resources may include skilled technicians, critical infrastructure support engineers, customer service resources, non-critical infrastructure support engineers, non-critical customer service resources, and business support resources, etc. In certain embodiments, a plurality of Support Resources 110 may be deployed to implement a change simultaneously. It will be appreciated that certain Support Resources 110 may have different skill sets and abilities to implement certain changes. In certain embodiments, Active Machine Learning Module may prioritize change records based on the availability of certain types of Support Resources 110. In some embodiments, Ticketing System 108 is configured to receive incident reports generated by the Active Machine Learning Module 104 from errors received via the Alert Messaging Bus 106 to determine if an existing incident will increase the risk or decrease the probability of the success of a change. The Ticketing System 108 and Change Record 150 may be accessed by the Support Resource 110.

The Alert Messaging Bus 106 is configured to transmit and receive data. The Alert Messaging Bus 106 serves as an information bus receiving information via different protocols from different systems which can produce errors. The Active Learning Module 104 is configured to monitor activity on the Alert Messaging Bus 106 and react in real-time to alerts detected on the Alert Messaging Bus. The Alert Messaging Bus 106 may be comprised of IT hardware known to those of ordinary skill in the art (storage, network, and computers using primarily Simple Network Management Protocol (SNMP) to communicate alerts). Business processes from provisioning systems would use an Application Programming Interface (API), SFTP, HTTPS to provide alerts to the Alert Messaging Bus 106 as the result of issues in provisioning or decommissioning infrastructure.

An Information Asset Network 118 is configured to communicate with the Alert Messaging Bus 106 via a Simple Network Management Protocol (SNMP) or Application Programming Interface (API), SFTP or other communications protocol.

As will be appreciated by those of skill in the art, the above description applies to a single organization support structure, but may similarly apply to many different technological environments. Organizations providing services may require Service Level Agreements for their products. In these situations, incident reporting may not be conducted automatically, but must be submitted by third parties. It will be appreciated that the described intelligent incident tracking and management system would be enabling in such an incident reporting environment. The Application Metadata Module 102 may contain specific data regarding any Service Level Agreements. For example, an Application A is defined as requiring a file be transmitted from 5:00-7:00 PM EST and if no file is transmitted, a fine will be levied. If the Alert Message Bus 106 transmits a message that the transfer has failed, the Active Machine Learning Module 104 will attempt to determine if it can repair the cause of the failed file transmission or create a high priority ticket to assign appropriate resources to resolve the issue.

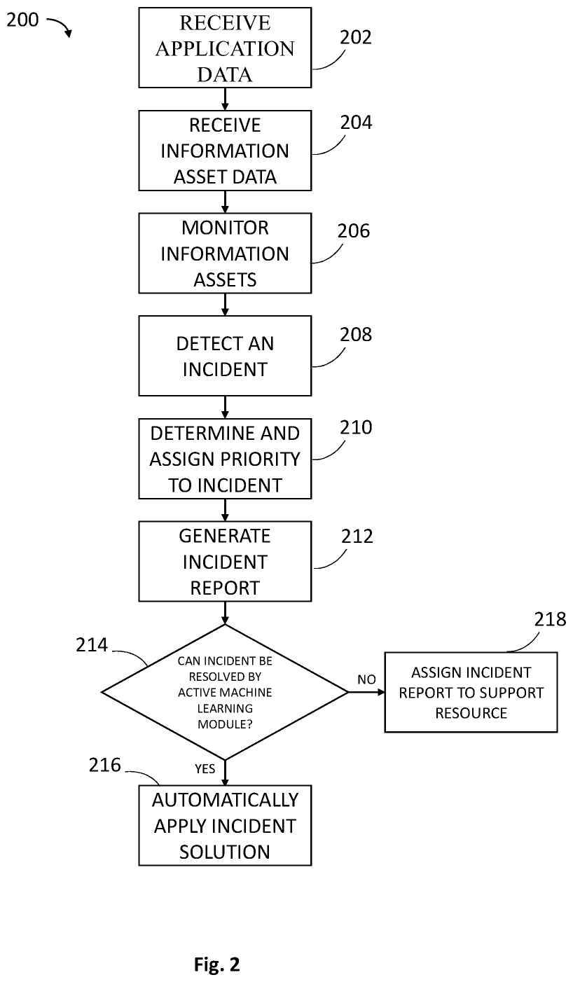

FIG. 2 illustrates a flow chart of an exemplary method 200 for intelligent incident management and tracking. It will be appreciated that the illustrated method and associated steps may be performed in a different order, with illustrated steps omitted, with additional steps added, or with a combination of reordered, combined, omitted, or additional steps.

At step 202, application data is received, for example, from Application Metadata Module 102. At step 204, information asset data is received, for example, from Asset Inventory Module 100. At step 206, information assets are monitored in order to detect an incident or error. At step 208, an incident is detected. At step 210, a priority is determined and assigned to the incident. In some embodiments, a severity of the incident is also determined and assigned. Once an incident is detected, an incident report may be generated based on the information asset data and the application data at step 212. At step 214, it is determined if the detected incident can be resolved automatically by the Active Machine Learning Module 104. If the incident may be automatically resolved the Active Machine Learning Module 104 may apply the incident solution at step 216. If the incident is determined to be not able to be resolved automatically, the incident report is assigned to a support resource at step 218.

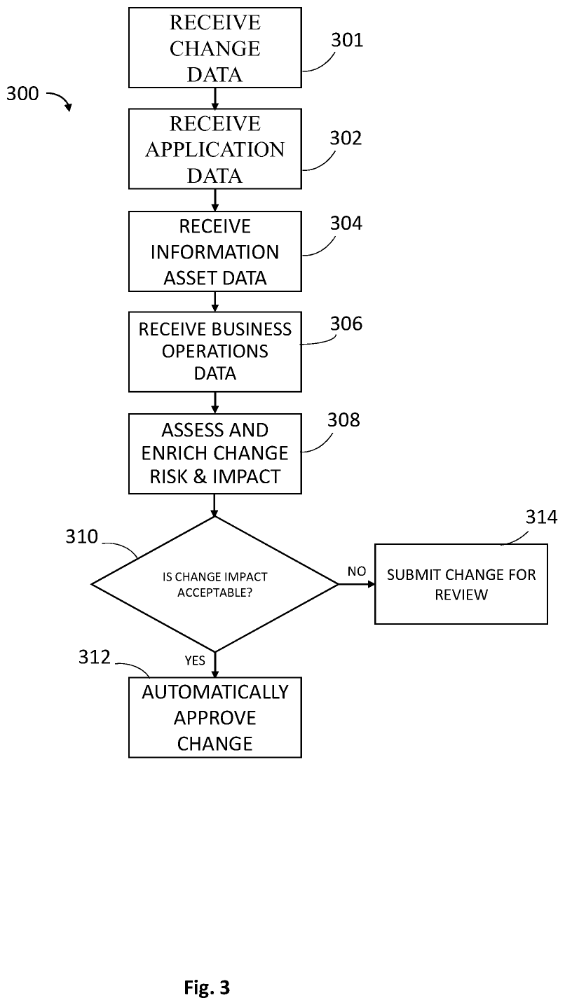

FIG. 3 illustrates of a flow chart of an exemplary 300 for intelligent change management and tracking. It will be appreciated that the illustrated method and associated steps may be performed in a different order, with illustrated steps omitted, with additional steps added, or with a combination of reordered, combined, omitted, or additional steps.

At step 301, change data is received. Change data may be a change request detected and/or received by the Active Machine Learning Module 104. In some embodiments, change data and/or a change request may be automatically generated in response to a detected incident. At step 302, application data is received, for example, from Application Metadata Module 102. At step 304, information asset data is received, for example, from Asset Inventory Module 100. At step 306, business operations data is received in order to correlate business impact related to a potential change. At step 308, the impact and risk of the potential change is assessed by Active Machine Learning Module 104. This assessment may include correlating the potential change with impacted assets, applications, and/or impact of a potential change on business operations. As impact and risk associated with a potential change is assessed, enriched data relating to the risk and impact of the potential change may be generated by the the Active Machine Learning Module 104. At step 310, it is determined if a potential change is acceptable in view of the risk and impact analysis performed in sep 308. In some embodiments, a potential change may be acceptable if it is performed during a specified timeframe, for example, when impacted systems are offline. If the impact of the change is acceptable, the change is automatically approved at step 312. If the change is not acceptable, the change is submitted for further review. In some embodiments, further review is performed by an asset or application owner or an authorized resource which can make further analysis and manually approve the change to be implemented.

The terms “incidents”, “errors”, and “alerts” as used herein are used interchangeably and refer to any incident, error, or alert of interest to the administrator of the present intelligent incident management and tracking system. It will be appreciated that other descriptors as known to those skilled in the art may be used to describe such events without affecting performance of the described systems.

The term “module” or “engine” used herein will be appreciated as comprising various configurations of computer hardware and/or software implemented to perform operations. In some embodiments, modules or engines as described may be represented as instructions operable to be executed by a processor and a memory. In other embodiments, modules or engines as described may be represented as instructions read or executed from a computer readable media. A module or engine may be generated according to application specific parameters or user settings. It will be appreciated by those of skill in the art that such configurations of hardware and software may vary, but remain operable in substantially similar ways.

It is to be understood that the detailed description is intended to be illustrative, and not limiting to the embodiments described. Other embodiments will be apparent to those of skill in the art upon reading and understanding the above description. Moreover, in some instances, elements described with one embodiment may be readily adapted for use with other embodiments. Therefore, the methods and systems described herein are not limited to the specific details, the representative embodiments, or the illustrative examples shown and described. Accordingly, departures may be made from such details without departing from the spirit or scope of the general aspects of the present disclosure.

What is claimed is:

1. A system for intelligent incident and change management, the system comprising:
an active machine learning module configured to:
receive application data;
receive information asset data;
monitor information assets to detect incidents, wherein when an incident is detected, the active machine learning module is further configured to determine and assign priority to the incident based on the application data and information asset data; and,
generate an incident report based on the detected incident and the assigned priority.

2. The system of claim 1, wherein application data comprises risk data.

3. The system of claim 1, wherein the active machine learning module is further configured to automatically resolve the detected incident.

4. The system of claim 1, wherein the active machine learning module is further configured to receive legal and compliance data.

5. The system of claim 4, wherein the active machine learning module is further configured to receive business operations data.

6. The system of claim 5, wherein the active machine learning module is further configured to determine and assign priority to the incident based on the application data, information asset data, legal and compliance data, and business operations data.

7. The system of claim 6, wherein the active machine learning module is further configured to determine an impact associated with a change required to resolve the incident report.

8. The system of claim 6, wherein the active machine learning module is further configured to automatically resolve the detected incident.

9. The system of claim 1, wherein the active machine learning module is further configured to:
transmit the incident report to a ticketing system; and,
assign the incident report to a support resource.

10. A method for intelligent incident and change management, the method comprising:
receiving application data;
receiving information asset data;
monitoring information assets to detect incidents;
detecting and incident and determining and assigning a priority to the incident based at least on the application data and the information asset data; and
generating an incident report based on the detected incident and assigned priority.

11. The method of claim 10, wherein the application data comprises risk data.

12. The method of claim 10, further comprising determining if the incident can be resolved automatically, and automatically resolving the detected incident.

13. The method of claim 10, further comprising receiving legal and compliance data.

14. The method of claim 13, further comprising receiving business operations data.

15. The method of claim 14, wherein determining and assigning priority to the incident is based on the application data, information asset data, legal and compliance data, and business operations data.

16. The method of claim 15, further comprising determining an impact associated with a change required to resolve the incident report.

17. The method of claim 10, further comprising:
transmitting the incident report to a ticketing system; and,
assigning the incident report to a support resource.

18. A system for intelligent incident management, the system comprising:
an active machine learning module configured to:
receive application data from an application metadata module;
receive information asset data form an asset inventory module;
receive legal and compliance data from a legal and compliance module;
receive business and operations data from a business and operations module;
monitor information assets to detect incidents, wherein when an incident is detected, the active machine learning module is further configured to determine and assign priority to the incident based on one of the application data, the information asset data, the legal and compliance data, or the business and operations data; and
generate an incident report based on the detected incident and the assigned priority.

19. The system of claim 18, wherein priority is determined and assigned based the business and operations data comprising a financial impact related to the detected incident.

20. The system of claim 19, wherein priority is determined and assigned based on the business and operations data comprising a financial impact related to the detected incident and a reputational impact related to the detected incident.
